(19) United States
(12) Patent Application Publication
(10) Pub. No.: US 2004/0081362 A1
(43) Pub. Date: Apr. 29, 2004

(54) Image processing method

(76) Inventor: Shih-Zheng Kuo, Yung Ho City (TW)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/684,711

(22) Filed: Oct. 15, 2003

(30) Foreign Application Priority Data
Oct. 25, 2002 (TW) 91125356

(51) Int. Cl. G06T 5/00; H04N 1/409

(52) U.S. Cl. 382/254; 382/274

(57) ABSTRACT

An image processing method is disclosed. The present invention is suitable for enhancing shadow bits of a digital signal of an image in a scanner and then transferring the digital signal into a computer to proceed the subsequent processing and output, wherein the present invention comprises the following steps: converting the analog signal of the image in the scanner into the digital signal; enhancing the shadow bits by a first Gamma curve; transferring the digital signal into the computer via a bus; proceeding an inverse to the digital signal by a second Gamma curve; image processing the digital signal; proceeding an image transformation to the digital signal by a third Gamma curve and then outputting the digital signal.

### FIELD OF THE INVENTION

The present invention relates to an image processing method, and more particularly, to an image processing method that can enhance shadow bits of a digital signal of an image in a scanner and then transfer the digital signal into a computer to proceed with the subsequent processing and output.

### BACKGROUND OF THE INVENTION

Recently, workstations and personal computers, etc. have been developed to have high performance and be able to proceed with rapid processing of full-color image. Accompanying with the development, scanners used to convert photos, slides, or manuscripts to digital data have become more and more popular.

The method by which the scanner gets the image is described as the following. Firstly, the light illuminates the document waiting for scanning. Then, the light reflected by the document illuminates the photoreceptor. Afterwards, the A/D converter converts the analog signal from the photoreceptor into the digital signal, and then transfers the digital signal to the computer.

Generally speaking, the scanning software of the scanner and the computer not only has basic functions of reading and transferring image, but also has tools used to adjust various parameters of images. The parameters are such as density, density range, highlight, shadow, and Gamma curve, etc.

Density means light and shade of an image on a document. Density range means the difference between the minimum density and the maximum density of an image. Highlight means the brightest area of an image, and shadow means the darkest area of an image. Moreover, a Gamma curve is a special curve of color tones. When the Gamma value equals to one, the curve is a straight line of 45 degrees, and that is, the input density and the output density are the same. The Gamma value not equal to one will brighten or darken the output.

Due to the feature of Gamma curve, Gamma correction will not affect the density range of image, but the distribution of density. Gamma correction affects the middle tones mainly. When an image is darkened, the highlight will be compressed and the shadow will be expanded. When an image is brightened, the highlight will be expanded and the shadow will be compressed. The Gamma correction is generally used to expand details of the shadow smoothly.

Usually, a conventional scanner has a built-in function of Gamma value correction in hardware. However, the processing ability of such the scanner in Gamma value correction is very weak and cannot be used to proceed with complicated processing. Consequently, in order to use the powerful data processing ability of the computer end, another conventional commonly used method of Gamma correction is to put the function of Gamma value correction into the post-processing of the computer end. Please refer to a conventional systematic block diagram of FIG. 1 showing that a digital image in a scanner is transferred into a computer to proceed with Gamma value correction. Firstly, a scanner 10 obtains an analog signal of an image of a document by an image-reading device (not shown). Then, the analog signal of the image of the document can be converted to a digital signal by an A/D converter 20 in the scanner 10. Afterwards, the digital signal is transferred to a computer 30 via a bus (not shown) between the scanner 10 and the computer 30. Then, the aforementioned digital signal of the image proceeds with Gamma correction by a Gamma correction curve 40. Afterwards, the digital signal of the image that has been corrected by Gamma correction can be outputted to a monitor (not shown) or can proceed with a further image processing as shown in the step of outputting image 50. However, the conventional method of Gamma correcting the digital image from the scanner as shown in FIG. 1 will cause the loss of the shadow bits and makes the data of the shadow not clear. Therefore, it is necessary to find a solution.

### SUMMARY OF THE INVENTION

Just as described above, the conventional method of Gamma correcting the digital image from the scanner causes the loss of the shadow bits and makes the data of the shadow not clear. Hence, an objective of the present invention is to provide an image processing method, thereby enhancing the shadow bits of the image in the scanner and then transferring the image into a computer to proceed the subsequent processing such as inverse.

According to the aforementioned objectives of the present invention, the present invention provides an image processing method suitable for enhancing at least one shadow bit of a digital signal of an image and then outputting the image, wherein the image processing method comprises the following steps: firstly, providing an A/D converter in the scanner to convert an analog signal of the image into the digital signal; next, enhancing the at least one shadow bit by a first Gamma curve; then, transferring the digital signal into the computer via a bus; then, inversing the digital signal of the at least one shadow bit that has been enhanced by a second Gamma curve; then, image processing the digital signal that has been inversed; and image transforming the digital signal that has been image processed by a third Gamma curve and then outputting the image.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a conventional systematic block diagram showing that a digital image in a scanner is transferred into a computer to proceed with a correction of Gamma value; and

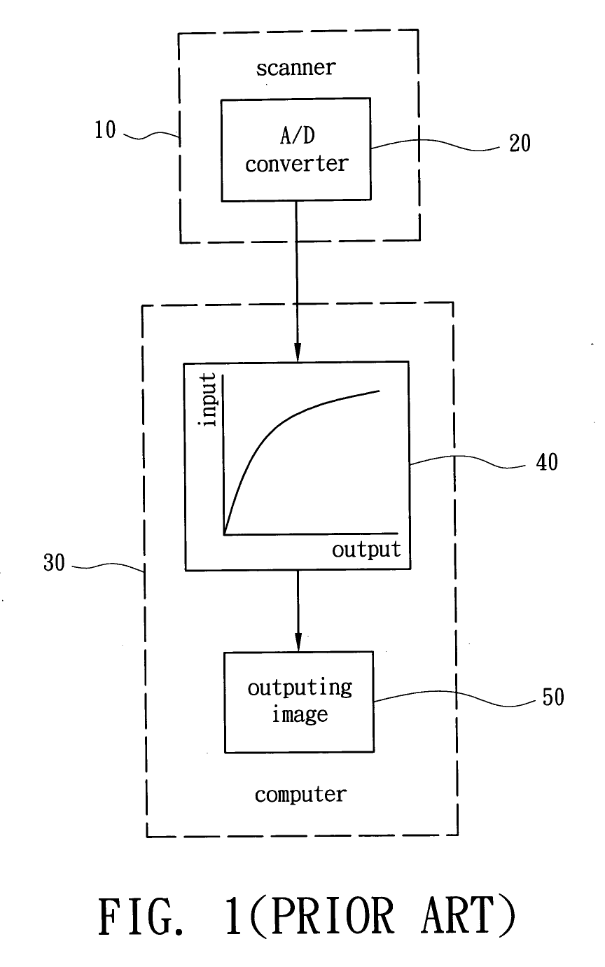

FIG. 2 is a systematic block diagram showing the image processing method according an embodiment of the present invention.

### DETAILED DESCRIPTION OF THE PREFERRED EMBODIMENT

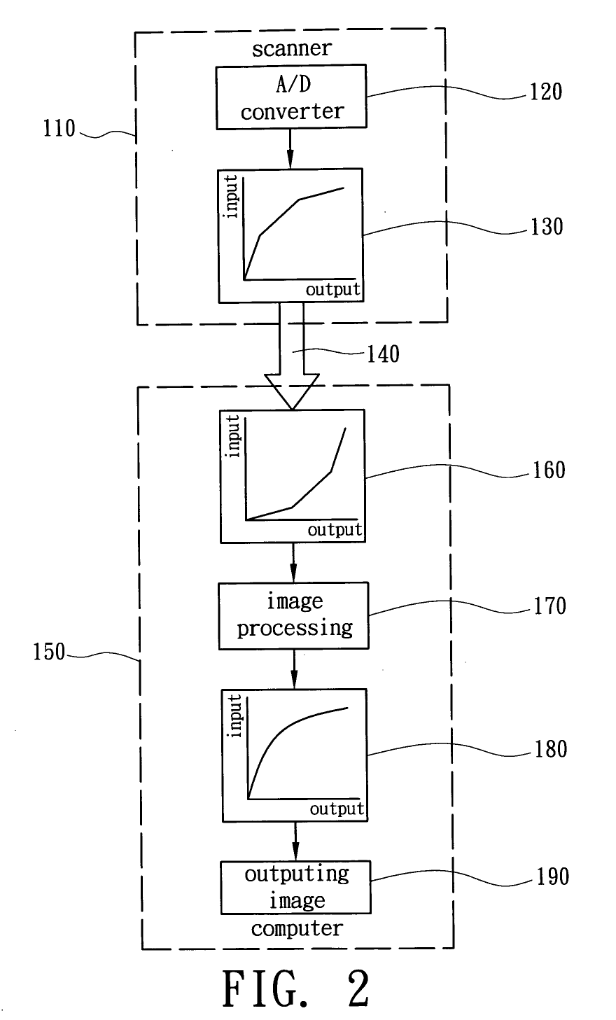

The present invention relates to an image processing method that can enhance shadow bits of a digital signal of an image in a scanner and then transfer the digital signal into a computer to proceed with the subsequent processing and output. Please refer to FIG. 2 showing a systematic block diagram of the image processing method according to an embodiment of the present invention. The following is the detailed description about those shown in FIG. 2.

Firstly, a scanner 110 obtains an analog signal of an image of a document by a light source, a mirror, a lens, and an image-reading device (the four elements not shown), etc. The aforementioned image reading device is such as a charge coupled device (CCD) or a photomultiplier tube (PMT), etc. Then, the analog signal of the image of the document can be converted to a digital signal by an A/D converter 120 in the scanner 110.

Then, at least one shadow bit of the digital signal of the aforementioned image can be expanded (enhanced) and at least one highlight bit of that can be compressed by a first Gamma curve 130 in the scanner 110. The first Gamma curve 130 is installed in the scanner 110 in a hardware form, wherein the hardware form is such as an application specific integrated circuit (ASIC) or a digital signal processing (DSP) module, etc. In practice, the first Gamma curve 130 can be simulated by a plurality of straight lines. For example, in FIG. 2, the first Gamma curve 130 is simulated by three segments of straight lines.

Afterwards, the aforementioned digital signal of the image is transferred to a computer 150 via a bus 140 between the scanner 110 and the computer 150. The type of the bus 140 can be such as a universal serial bus (USB), a parallel port, or a small computer system interface (SCSI), etc.

Then, the aforementioned digital signal of the image is inversed (normalized) by a second Gamma curve 160. The second Gamma curve 160 used in this step can be obtained by looking up in a table or by a formula.

After that, as shown in a step of image processing 170, the digital signal of the image is image processed appropriately via the assistance of the scanning software.

Then, the aforementioned digital signal of the image is image transformed by a third Gamma curve 180. The third Gamma curve 180 can be obtained by looking up in a table, and the third Gamma curve 180 is installed in the scanning software in a form of software. Consequently, the digital signal of the image can be adjusted to have the effect of the enhanced shadow as the shown third Gamma curve 180, thereby achieving the objective of the present invention.

Afterwards, the digital signal of the image that has been corrected by the method of the present invention can be outputted to a monitor (not shown) or can proceed with a further image processing as shown in the step of outputting image 190.

To sum up, an advantage of the present invention is to provide an image processing method, thereby enhancing the shadow bits of the image in the scanner and then transferring the image into the computer to proceed the subsequent processing such as inverse.

As is understood by a person skilled in the art, the foregoing preferred embodiments of the present invention are illustrations of the present invention rather than limitations of the present invention. It is intended to cover various modifications and similar arrangements comprised within the spirit and scope of the appended claims, the scope of which should be accorded the broadest interpretation so as to encompass all such modifications and similar structure.

What is claimed is:

1. An image processing method suitable for enhancing at least one shadow bit of a digital signal of an image and then outputting the image, wherein the image processing method comprises:
enhancing the at least one shadow bit by a first Gamma curve;
inversing the digital signal of the at least one shadow bit that has been enhanced by a second Gamma curve;
image processing the digital signal that has been inversed; and
image transforming the digital signal that has been image processed by a third Gamma curve and then outputting the image.

2. The image processing method according to claim 1, wherein the step of enhancing the at least one shadow bit by the first Gamma curve proceeds in a scanner.

3. The image processing method according to claim 2, wherein the first Gamma curve is installed in the scanner in a hardware form.

4. The image processing method according to claim 3, wherein the hardware form is an application specific integrated circuit (ASIC).

5. The image processing method according to claim 3, wherein the hardware form is a digital signal processing (DSP) module.

6. The image processing method according to claim 1, wherein the second Gamma curve is obtained by looking up in a table.

7. The image processing method according to claim 1, wherein the second Gamma curve is obtained from a formula.

8. The image processing method according to claim 1, wherein the step of inversing the digital signal by a second Gamma curve proceeds in a computer.

9. The image processing method according to claim 1, wherein the step of image transforming the digital signal by a third Gamma curve and then outputting the image proceeds in a computer.

10. The image processing method according to claim 1, wherein the third Gamma curve is obtained by looking up in a table.

11. An image processing method suitable for enhancing at least one shadow bit of a digital signal of an image in a scanner and then transferring the digital signal to a computer to proceed with a subsequent processing and an output, wherein the image processing method comprises:
providing an A/D converter in the scanner to convert an analog signal of the image into the digital signal;
enhancing the at least one shadow bit by a first Gamma curve;
transferring the digital signal of the at least one shadow bit that has been enhanced to the computer by a bus;
inversing the digital signal that has been transferred to the computer by a second Gamma curve;
image processing the digital signal that has been inversed; and
image transforming the digital signal that has been image processed by a third Gamma curve and then outputting the image.

12. The image processing method according to claim 11, wherein the bus is a universal serial bus (USB).

13. The image processing method according to claim 11, wherein the bus is a parallel port.

14. The image processing method according to claim 11, wherein the bus is a small computer system interface (SCSI).

15. The image processing method according to claim 11, wherein the second Gamma curve is obtained by looking up in a table.

16. The image processing method according to claim 11, wherein the second Gamma curve is obtained from a formula.

17. The image processing method according to claim 11, wherein the first Gamma curve is installed in the scanner in a hardware form.

18. The image processing method according to claim 17, wherein the hardware form is an ASIC.

19. The image processing method according to claim 17, wherein the hardware form is a DSP module.

20. The image processing method according to claim 11, wherein the third Gamma curve is obtained by looking up in a table.
